(19) United States
(12) Patent Application Publication
(10) Pub. No.: US 2025/0265457 A1
(43) Pub. Date: Aug. 21, 2025

(54) CASCADING COMMAND SET ENGINEERING

(71) Applicant: Citibank, N.A., New York, NY (US)

(72) Inventors: Maneet Sharma, New York, NY (US); Adar K. Danait, New York, NY (US); Flora P. Sah, New York, NY (US); Krishnendu Chatterjee, New York, NY (US); Rama Koteswara Rao Kandimalla, New York, NY (US); Pavithra Araleri Visweswariah, New York, NY (US); Djona Fegnem, New York, NY (US); Swati Mittal, New York, NY (US); Paul Joseph Zakharia, New York, NY (US); Paul Edward Hibbs, New York, NY (US); James Michael Iacona, New York, NY (US)

(21) Appl. No.: 18/582,425

(22) Filed: Feb. 20, 2024

(51) Int. Cl. G06N 3/08

(52) U.S. Cl. CPC G06N 3/08

(57) ABSTRACT

A component risk control generator includes a set of machine learning models, an automatic command set generator, and a model quality assessment engine. Using a set of received input items, the automatic command set generator generates a component activity generator command set. A trained upstream machine learning model generates a component activity output set, which is used to generate a set of cascading command sets. Using at least one command set in the set of cascading command sets, a set of trained downstream machine learning models generate a plurality of cascading command sets and downstream output sets based thereon. The output sets can be validated using the model quality assessment engine.

### TECHNICAL FIELD

The systems, methods, and computer-readable media disclosed herein relate generally to automatic prompt engineering, such as automatic prompt engineering in systems for generative model sequencing in artificial intelligence/machine learning (AI/ML) simulation and modeling. Some implementations described herein relate to automatic prompt engineering for sequences of AI/ML models, such as AI/ML models used in risk control systems.

### BACKGROUND

Prompt engineering, also sometimes referred to as command set engineering or instruction set engineering, is a component of machine learning, specifically within the domain of natural language processing (NLP). Prompt engineering is a technique that involves creation and use of prompts to guide the output of large language models (LLMs), which are artificial intelligence systems (e.g., transformers, neural networks) that can generate text based on the input they are given.

### BRIEF DESCRIPTION OF THE DRAWINGS

FIG. 1 shows an example computing environment that includes a computing platform for cascading command set engineering, in accordance with some implementations of the present technology.

FIGS. 2-1 and 2-2 show an example component risk generator application, which can operate as part of the computing platform for cascading command set engineering, in accordance with some implementations of the present technology.

FIG. 3 illustrates a layered architecture of an artificial intelligence (AI) system that can implement the machine learning models of the a computing platform for cascading command set engineering, in accordance with some implementations of the present technology.

FIGS. 4A, 4B-1 and 4B-2 show an example architecture and graphical user interface (GUI) of a component risk corrector application, which can operate as part of the computing platform for cascading command set engineering, in accordance with some implementations of the present technology.

FIG. 5 is a flowchart depicting an example method of operation of the computing platform of FIG. 1, in accordance with some implementations of the present technology.

FIG. 6 is a block diagram showing some of the components typically incorporated in at least some of the computer systems and other devices on which the computing platform operates in accordance with some implementations of the present technology.

FIG. 7 is a system diagram illustrating an example of a computing environment in which the computing platform operates in some implementations of the present technology.

The drawings have not necessarily been drawn to scale. For example, some components and/or operations may be separated into different blocks or combined into a single block for the purposes of discussion of some of the embodiments of the disclosed system. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents and alternatives falling within the scope of the technology as defined by the appended claims.

### DETAILED DESCRIPTION

Disclosed herein are systems, methods, and computer-readable media for automatic prompt (command set, instruction set) engineering, such as automatic prompt engineering in systems for AI/ML-based simulation and modeling.

Prompts can be used to enable generative AI models to generate answers to user questions. However, a technical problem emerges when AI models are applied to answer complex questions: running AI models and optimizing them to increase output accuracy becomes computationally expensive as the questions increase in complexity, particularly when the tasks articulated in a particular prompt necessitate performing recursive and/or sequential operations. For instance, an answer to a particular question might be based on a series of intermediate responses or computations. Asking a large model (e.g., a model trained on a large corpus of data and having a high number of layers and parameters) to return a response to a composite question (e.g., “please generate a list of activities associated with process component XYZ, their associated risks, and, for the associated risks, controls and monitoring strategies”) can result in computationally expensive responses. Additionally, such responses can be unusable due to overfitting of the model to a particular corpus of training data. In fact, training large models to answer complex questions can become impractical because training data sets would have to become extremely large to account for permutations/combinations in data.

Discussed herein are techniques for solving these technical problems by breaking large, complex prompts into smaller, comparatively more tailored prompts that each focus on individual segments in a question chain. Automatically generated question chains enable implementation of cascading, smaller AI models that can be executed in flexibly-structured loops, sequences, or combinations of loops and sequences. The described AI models can be individually trained, which minimizes the possibility of overfitting. Accordingly, the techniques described herein can optimize the use of computational resources (e.g., memory units, processor units, networking units, and the like) needed to run the AI models. Furthermore, the techniques described herein increase model transparency, lineage/source tracking, and/or accuracy by enabling verification of intermediate model outputs.

Although, in an illustrative use case, implementations described herein relate to automatic prompt engineering in risk control systems, the techniques described herein also relate more generally to an environment where one might find it advantageous to sequence a set of AI/ML models or model execution cycles.

Turning now to an example use case involving risk control systems, consider an Activity-Risk-Control-Monitoring (A-R-C-M) chain aimed at determining activities (e.g., tasks, process units) associated with a particular technology (e.g., “cloud computing”), operation (e.g., “mobile deposit of checks”), or business process (e.g., “offboarding of an executive”). A particular activity in a set of activities can be associated with a set of risks. Risks in the set of risks can be associated with sets of risk controls. Controls in a particular set of risk controls can be associated with monitoring activities. In the A-R-C-M framework, systems can be thought of in terms of system components (e.g., front-end technologies, back-end technologies, customer-facing operations, back-office operations), and activities can be mapped to components. Using traditional systems, determining and accounting for activities and their corresponding risks and mitigators (C-M) can be time-consuming and error-prone. However, merely automating the process via an AI model would be impractical due to a high likelihood of model overfitting to training data and high computational costs.

Accordingly, as discussed herein, the disclosed computing platform decomposes the A-R-C-M process. To that end, a component risk control generator can include a set of machine learning models, an automatic prompt generator, and a model quality assessment (validator) engine. Using a set of received input items, the automatic prompt generator can generate a component activity generator prompt. A trained upstream machine learning model can generate a component activity output set, which can be used to generate a set of cascading prompts. At specific stages in the A-R-C-M chain, the prompts are designed to optimize the corresponding model's responses for a specific task (e.g., the task of generating sets of activities, risks, components, and/or monitoring operations). Using at least one command set in the set of cascading command sets, trained downstream machine learning models can generate downstream output sets. The downstream output sets can include various AI-generated items in the A-R-C-M chain. The disclosed computing platform can be configured to use the AI model outputs (items in the A-R-C-M chain) or their derivatives to generate downstream prompts.

As disclosed herein, the output sets can be validated using the model quality assessment engine, which additionally minimizes the possibility of trained model overfitting. The cascading architecture described herein enables output validation at intermediate points in the A-R-C-M chain, which increases accuracy of output and minimizes the possibility of overfitting to sets of training data while keeping the training data sets comparatively smaller (e.g., at 50 terabytes or under).

### Example Embodiments of a Computing Platform for Cascading Command Set Engineering

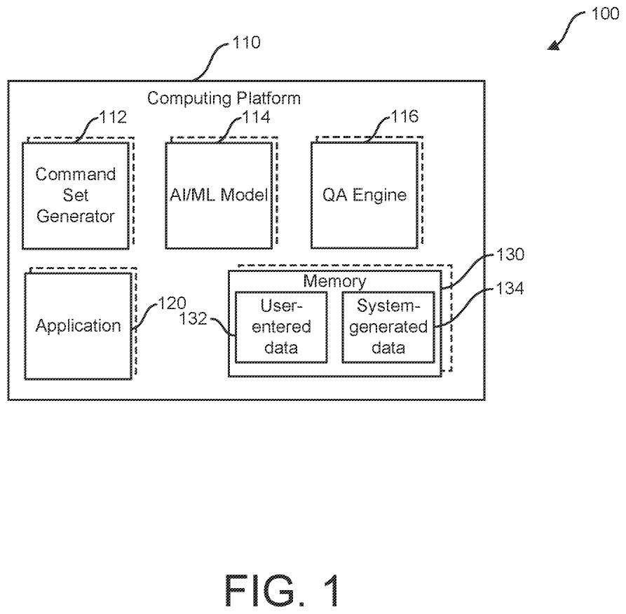

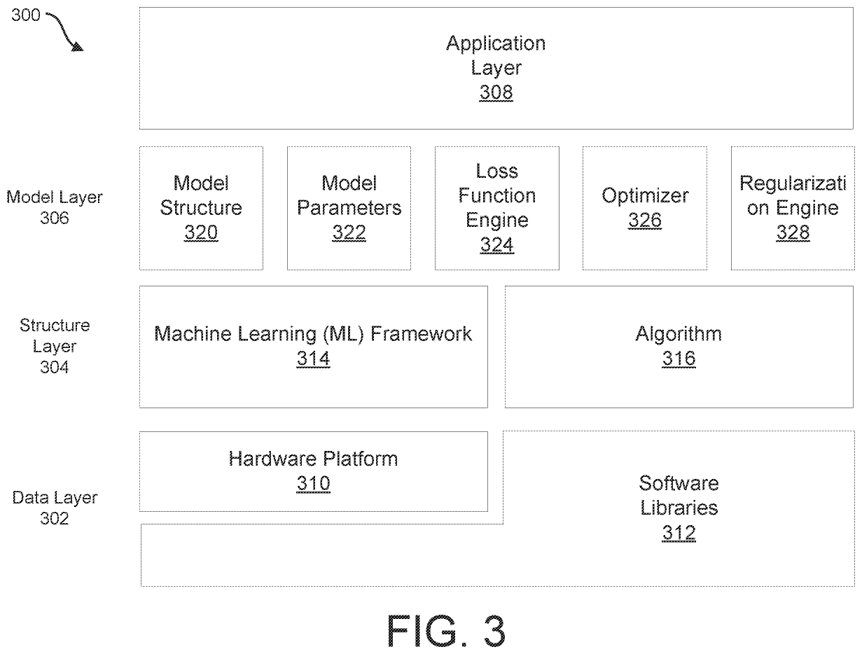

FIG. 1 shows an example computing environment 100 that includes a computing platform 110 for cascading command set engineering, in accordance with some implementations of the present technology. The computing platform 110 enables automatic creation of prompt chains for AI models, which can be generative AI models, neural networks, transformers, or other suitable models, such as the models described in relation to FIG. 3. Use cases for the computing platform 110 include generation of automatic prompt chains for sequences, loops, conversations, and other sets of computer-executable commands that may use AI models. Example use case domains include cybersecurity applications, conversational AI applications, risk control applications, financial applications, banking applications, and so forth. Example use cases include AI-augmented scenario automation, conversational AI, content retrieval, and so forth.

As shown, the computing platform 110 includes one or more units or engines, such as the command set generator 112, AI model 114, and quality assessment engine 116. As used herein, the term “engine” refers to one or more sets of computer-executable instructions, in compiled or executable form, that are stored on non-transitory computer-readable media and can be executed by one or more processors to perform software- and/or hardware-based computer operations. The computer-executable instructions can be special-purpose computer-executable instructions to perform a specific set of operations as defined by parametrized functions, specific configuration settings, special-purpose code, and/or the like. The engines can generate and/or receive various electronic messages.

The engines can be accessible via one or more computer applications 120. Computer applications 120 can be included in the computing platform 110 and/or can be communicatively coupled to the computing platform 110 via a network. The computer applications 120 can interact with the various units or engines of the computing platform 110 by running computer-based commands, invoking executables, calling application programming interface (API) functions, and so forth. The computer applications 120 can be configured to execute computer operations to support various use cases described herein. For example, computer applications 120 can include risk management applications, asset management applications, project management applications, interfaces to generative AI frameworks, and so forth. In an example use case, an application 120 can include the component risk generator 220 and/or the component risk corrector 420, described further herein.

As described, the command set generator 112 can perform various prompt generation tasks. For example, the command set generator 112 can receive a natural language prompt, question, or the like. The command set generator 112 can parse from the question to extract items (e.g., tokens) from the question. The extracted items can correspond to various elements of a prompt for an AI model. These elements can include, for example, context specifiers, knowledge domain specifiers, use cases, instructions, input items or references thereto, output specifications, and so forth. The command set generator 112 can maintain a database of data sources and can access the data sources to retrieve items that map to the items extracted from questions. For example, assuming a question asks about “computer security issues”, the command set generator 112 can improve the quality of the prompt (and, therefore, of expected output), to replace or qualify the “computer security issues” clause with a reference to a vulnerability database (for example, the National Vulnerability Database).

The command set generator 112 can also construct prompts or feature maps for the AI models 114, automatically cause AI models 114 to be executed, and receive additional outputs from the AI models 114. In some implementations, the command set generator 112 can specify output formats, such as blocks of text, tables, key-value pairs, and so forth. The command set generator 112 can extract values from the outputs, generate additional prompts based on the extracted values, and execute additional (downstream) AI models 114 based on the additional prompts.

To link items in sequences of prompts and AI model executions, the command set generator can maintain an in-memory and/or on-disk memory map 130, which can include user-entered data 132 (questions, corrections) and system-generated data 134 (prompts, input feature maps, output items). As the AI models 114 generate outputs, the output items can be stored as part of system-generated data 134. Chunks of various related items in memory map 130 can be linked, which enables management of complex prompt and output chains and facilitates model transparency. For example, stored intermediate outputs in prompt chains can be retained in memory maps 130 and retrieved for validation, as described further herein. Memory maps 130 can also be used to capture corrections via user-entered data 132, which enables linkage of corrections to outputs captured in system generated data 134. This enables the technical advantage of creating targeted training sets to improve performance of specific AI models 114 in sequences of AI models 114.

The computing platform 110 can enable users to review model output and provide corrections as described further herein. To that end, the quality assessment engine 116 can enable the computing platform 110 to retrieve prompts and/or model outputs from memory maps 130, visualize the prompts and/or model outputs, and capture feedback regarding the prompts and/or model outputs.

### Example Embodiments of a Component Risk Generator of the Computing Platform for Cascading Command Set Engineering

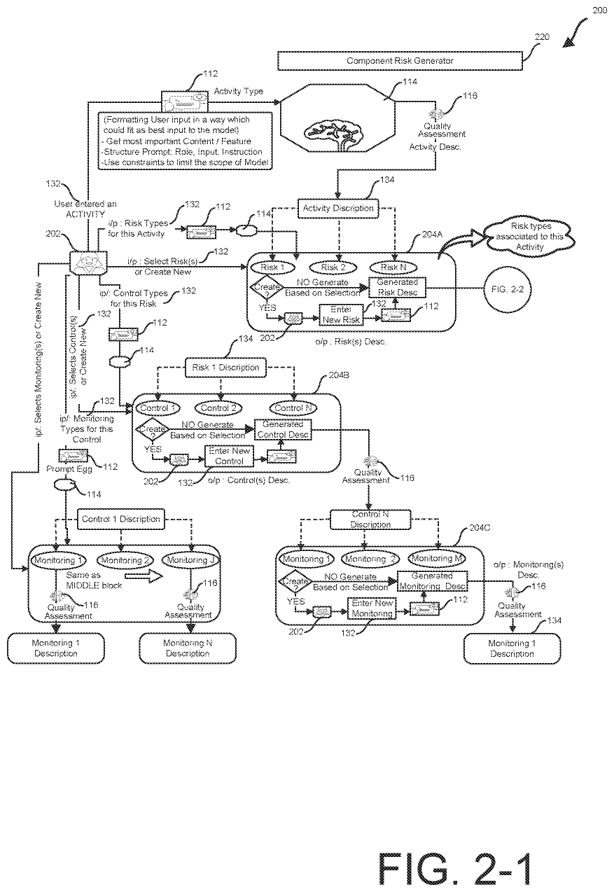

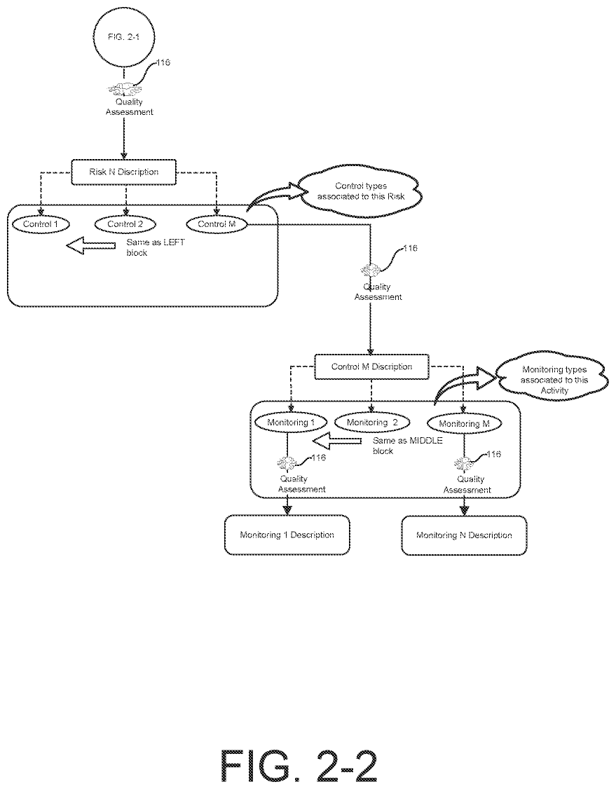

FIGS. 2-1 and 2-2 show an example diagram 200 of a component risk generator 220, which can operate as part of the computing platform 110 for cascading command set engineering. The component risk generator 220 can be implemented as an application 120 described in relation to FIG. 1. The component risk generator 220 can be configured to support a variety of use case domains, such as risk management, and can be operable to create complete A-R-C-M descriptions automatically and standardize the process of creating A-R-C-Ms (sets of activities, sets of risks, sets of controls, or sets of monitoring recommendations).

In an example use case, the component risk generator 220 can be configured to generate prompt sequences in A-R-C-M chains. To that end, the component risk generator 220 can include instances of the command set generator 112, AI model 114, and quality assessment engine 116. The instances of the command set generator 112 can be configured to manage the lifecycle of prompts in A-R-C-M chains (generate prompts, optimize prompts, execute prompts, manage memory maps, and so forth).

The AI models 114 can include neural networks, transformers, and/or, other suitable models, such as LLMs (e.g., GPT, BERT, Llama). Generally, as shown according to a non-limiting example, the AI models 114 can be utilized to generate sets of outputs for A-R-C-M chains and/or to assess the quality of the generated outputs.

To generate sets of outputs for A-R-C-M chains, the AI models 114 can be trained AI models structured to receive feature maps sufficient to enable the AI models 114 to generate sets of activities, risks, controls, and/or monitoring operations in A-R-C-M chains. For example, an instance of the AI model 114 structured to generate activities A can be trained on elements that include use constraints (particular geographical location, region, line of business, layer in a technology stack), roles (entities responsible for specific facets of an activity), and/or activity data (e.g., company strategic plans, service offerings, service modalities, product roadmaps, product feature sets). For example, an instance of the AI model 114 structured to generate risks R can be trained on elements that include use constraints, roles, and/or risk data (e.g., risk data, fraud data, KYC (know your customer) data, system vulnerability data, reported security breach data). For example, an instance of the AI model 114 structured to generate controls C and/or monitoring M recommendations can be trained on elements that include use constraints, roles, and/or control data (e.g., procedure manuals, process manuals, best-practice guides, technology implementation guides, project management plans, program management roadmaps).

To assess the quality of the generated outputs, the AI models 114 can be trained AI models (e.g., transformer models) structured to receive feature maps sufficient to enable the AI models 114 to answer “5 W” (what, why, where, who, when) questions in order to assess the quality of output against the 5 W checkpoints. The output can include automatically generated sets of activities, risks, controls, and/or monitoring recommendations. The AI models 114 can generate outputs, metrics, and so forth, which can cause the quality assessment engine 116 to flag records for manual review, as described further herein.

In operation on the component risk generator 220, a user 202 can enter a question relating to an activity. The component risk generator 220 can generate a prompt based on the user-entered question. The component risk generator 220 can cause an AI model 114 to generate a set of activity descriptions. After being validated using the quality assessment engine 116, a particular activity description in the set of activity descriptions can (automatically or upon being selected by a user via a GUI) be used to generate a downstream prompt for another instance or iteration AI model 114, and so forth until a tree that includes a set of A-R-C-M sequences is generated. The operations for generating the R-C-M sequences can include output validation loops (204a, 204b, 204c). In the output validation loops (204a, 204b, 204c), the user 202 is enabled to review the automatically-generated R, C, or M sets and/or edit the sets as described further herein. For example, the user 202 can change, remove, or add specific risks, controls, or monitoring recommendations to the respective sets.

### Example Implementations of AI/ML Models

FIG. 3 illustrates a layered architecture of an artificial intelligence (AI) system 300 that can implement the machine learning models of the computing platform 110 of FIG. 1, in accordance with some implementations of the present technology.

As shown, the AI system 300 can include a set of layers, which conceptually organize elements within an example network topology for the AI system's architecture to implement a particular AI model. Generally, an AI model is a computer-executable program implemented by the AI system 300 that analyses data to make predictions. Information can pass through each layer of the AI system 300 to generate outputs for the AI model. The layers can include a data layer 302, a structure layer 304, a model layer 306, and an application layer 308. The algorithm 316 of the structure layer 304 and the model structure 320 and model parameters 322 of the model layer 306 together form an example AI model. The optimizer 326, loss function engine 324, and regularization engine 328 work to refine and optimize the AI model, and the data layer 302 provides resources and support for application of the AI model by the application layer 308.

The data layer 302 acts as the foundation of the AI system 300 by preparing data for the AI model. As shown, the data layer 302 can include two sub-layers: a hardware platform 310 and one or more software libraries 312. The hardware platform 310 can be designed to perform operations for the AI model and include computing resources for storage, memory, logic and networking. The hardware platform 310 can process amounts of data using one or more servers. The servers can perform backend operations such as matrix calculations, parallel calculations, machine learning (ML) training, and the like. Examples of servers used by the hardware platform 310 include central processing units (CPUs) and graphics processing units (GPUs). CPUs are electronic circuitry designed to execute instructions for computer programs, such as arithmetic, logic, controlling, and input/output (I/O) operations, and can be implemented on integrated circuit (IC) microprocessors. GPUs are electric circuits that were originally designed for graphics manipulation and output but may be used for AI applications due to their vast computing and memory resources. GPUs use a parallel structure that generally makes their processing more efficient than that of CPUs. In some instances, the hardware platform 310 can include Infrastructure as a Service (IaaS) resources, which are computing resources, (e.g., servers, memory, etc.) offered by a cloud services provider. The hardware platform 310 can also include computer memory for storing data about the AI model, application of the AI model, and training data for the AI model. The computer memory can be a form of random-access memory (RAM), such as dynamic RAM, static RAM, and non-volatile RAM.

The software libraries 312 can be thought of suites of data and programming code, including executables, used to control the computing resources of the hardware platform 310. The programming code can include low-level primitives (e.g., fundamental language elements) that form the foundation of one or more low-level programming languages, such that servers of the hardware platform 310 can use the low-level primitives to carry out specific operations. The low-level programming languages do not require much, if any, abstraction from a computing resource's instruction set architecture, allowing them to run quickly with a small memory footprint. Examples of software libraries 312 that can be included in the AI system 300 include Intel Math Kernel Library, Nvidia cuDNN, Eigen, and Open BLAS.

The structure layer 304 can include an ML framework 314 and an algorithm 316. The ML framework 314 can be thought of as an interface, library, or tool that allows users to build and deploy the AI model. The ML framework 314 can include an open-source library, an application programming interface (API), a gradient-boosting library, an ensemble method, and/or a deep learning toolkit that work with the layers of the AI system facilitate development of the AI model. For example, the ML framework 314 can distribute processes for application or training of the AI model across multiple resources in the hardware platform 310. The ML framework 314 can also include a set of pre-built components that have the functionality to implement and train the AI model and allow users to use pre-built functions and classes to construct and train the AI model. Thus, the ML framework 314 can be used to facilitate data engineering, development, hyperparameter tuning, testing, and training for the AI model. Examples of ML frameworks 314 that can be used in the AI system 300 include TensorFlow, PyTorch, Scikit-Learn, Keras, Cafffe, LightGBM, Random Forest, and Amazon Web Services.

The algorithm 316 can be an organized set of computer-executable operations used to generate output data from a set of input data and can be described using pseudocode. The algorithm 316 can include complex code that allows the computing resources to learn from new input data and create new/modified outputs based on what was learned. In some implementations, the algorithm 316 can build the AI model through being trained while running computing resources of the hardware platform 310. This training allows the algorithm 316 to make predictions or decisions without being explicitly programmed to do so. Once trained, the algorithm 316 can run at the computing resources as part of the AI model to make predictions or decisions, improve computing resource performance, or perform tasks. The algorithm 316 can be trained using supervised learning, unsupervised learning, semi-supervised learning, and/or reinforcement learning.

Using supervised learning, the algorithm 316 can be trained to learn patterns (e.g., map input data to output data) based on labeled training data. The training data may be labeled by an external user or operator. The user may label the training data based on one or more classes (e.g., use constrains, activity categories, risk categories, control categories, monitoring categories) and trains the AI model by inputting the training data to the algorithm 316. The algorithm determines how to label the new data based on the labeled training data. The user can facilitate collection, labeling, and/or input via the ML framework 314. In some instances, the user may convert the training data to a set of feature vectors for input to the algorithm 316. Once trained, the user can test the algorithm 316 on new data to determine if the algorithm 316 is predicting accurate labels for the new data. For example, the user can use cross-validation methods to test the accuracy of the algorithm 316 and retrain the algorithm 316 on new training data if the results of the cross-validation are below an accuracy threshold.

Supervised learning can involve classification and/or regression. Classification techniques involve teaching the algorithm 316 to identify a category of new observations based on training data and are used when input data for the algorithm 316 is discrete. Said differently, when learning through classification techniques, the algorithm 316 receives training data labeled with categories (e.g., classes) and determines how features observed in the training data relate to the categories. Once trained, the algorithm 316 can categorize new data by analyzing the new data for features that map to the categories. Examples of classification techniques include boosting, decision tree learning, genetic programming, learning vector quantization, k-nearest neighbor (k-NN) algorithm, and statistical classification.

Regression techniques involve estimating relationships between independent and dependent variables and are used when input data to the algorithm 316 is continuous. Regression techniques can be used to train the algorithm 316 to predict or forecast relationships between variables. To train the algorithm 316 using regression techniques, a user can select a regression method for estimating the parameters of the model. The user collects and labels training data that is input to the algorithm 316 such that the algorithm 316 is trained to understand the relationship between data features and the dependent variable(s). Once trained, the algorithm 316 can predict missing historic data or future outcomes based on input data. Examples of regression methods include linear regression, multiple linear regression, logistic regression, regression tree analysis, least squares method, and gradient descent. In an example implementation, regression techniques can be used, for example, to estimate and fill-in missing data for machine-learning based pre-processing operations.

Under unsupervised learning, the algorithm 316 learns patterns from unlabeled training data. In particular, the algorithm 316 is trained to learn hidden patterns and insights of input data, which can be used for data exploration or for generating new data. Here, the algorithm 316 does not have a predefined output, unlike the labels output when the algorithm 316 is trained using supervised learning. Said another way, unsupervised learning is used to train the algorithm 316 to find an underlying structure of a set of data, group the data according to similarities, and represent that set of data in a compressed format.

A few techniques can be used in supervised learning: clustering, anomaly detection, and techniques for learning latent variable models. Clustering techniques involve grouping data into different clusters that include similar data, such that other clusters contain dissimilar data. For example, during clustering, data with possible similarities remain in a group that has less or no similarities to another group. Examples of clustering techniques density-based methods, hierarchical based methods, partitioning methods, and grid-based methods. In one example, the algorithm 316 may be trained to be a k-means clustering algorithm, which partitions n observations in k clusters such that each observation belongs to the cluster with the nearest mean serving as a prototype of the cluster. Anomaly detection techniques are used to detect previously unseen rare objects or events represented in data without prior knowledge of these objects or events. Anomalies can include data that occur rarely in a set, a deviation from other observations, outliers that are inconsistent with the rest of the data, patterns that do not conform to well-defined normal behavior, and the like. When using anomaly detection techniques, the algorithm 316 may be trained to be an Isolation Forest, local outlier factor (LOF) algorithm, or K-nearest neighbor (k-NN) algorithm. Latent variable techniques involve relating observable variables to a set of latent variables. These techniques assume that the observable variables are the result of an individual's position on the latent variables and that the observable variables have nothing in common after controlling for the latent variables. Examples of latent variable techniques that may be used by the algorithm 316 include factor analysis, item response theory, latent profile analysis, and latent class analysis.

The model layer 306 implements the AI model using data from the data layer and the algorithm 316 and ML framework 314 from the structure layer 304, thus enabling decision-making capabilities of the AI system 300. The model layer 306 includes a model structure 320, model parameters 322, a loss function engine 324, an optimizer 326, and a regularization engine 328.

The model structure 320 describes the architecture of the AI model of the AI system 300. The model structure 320 defines the complexity of the pattern/relationship that the AI model expresses. Examples of structures that can be used as the model structure 320 include decision trees, support vector machines, regression analyses, Bayesian networks, Gaussian processes, genetic algorithms, and artificial neural networks (or, simply, neural networks). The model structure 320 can include a number of structure layers, a number of nodes (or neurons) at each structure layer, and activation functions of each node. Each node's activation function defines how to node converts data received to data output. The structure layers may include an input layer of nodes that receive input data, an output layer of nodes that produce output data. The model structure 320 may include one or more hidden layers of nodes between the input and output layers. The model structure 320 can be an Artificial Neural Network (or, simply, neural network) that connects the nodes in the structured layers such that the nodes are interconnected. Examples of neural networks include Feedforward Neural Networks, convolutional neural networks (CNNs), Recurrent Neural Networks (RNNs), Autoencoder, and Generative Adversarial Networks (GANs).

The model parameters 322 represent the relationships learned during training and can be used to make predictions and decisions based on input data. The model parameters 322 can weight and bias the nodes and connections of the model structure 320. For instance, when the model structure 320 is a neural network, the model parameters 322 can weight and bias the nodes in each layer of the neural networks, such that the weights determine the strength of the nodes and the biases determine the thresholds for the activation functions of each node. The model parameters 322, in conjunction with the activation functions of the nodes, determine how input data is transformed into desired outputs. The model parameters 322 can be determined and/or altered during training of the algorithm 316.

The loss function engine 324 can determine a loss function, which is a metric used to evaluate the AI model's performance during training. For instance, the loss function engine 324 can measure the difference between a predicted output of the AI model and the actual output of the AI model and is used to guide optimization of the AI model during training to minimize the loss function. The loss function may be presented via the ML framework 314, such that a user can determine whether to retrain or otherwise alter the algorithm 316 if the loss function is over a threshold. In some instances, the algorithm 316 can be retrained automatically if the loss function is over the threshold. Examples of loss functions include a binary-cross entropy function, hinge loss function, regression loss function (e.g., mean square error, quadratic loss, etc.), mean absolute error function, smooth mean absolute error function, log-cosh loss function, and quantile loss function.

The optimizer 326 adjusts the model parameters 322 to minimize the loss function during training of the algorithm 316. In other words, the optimizer 326 uses the loss function generated by the loss function engine 324 as a guide to determine what model parameters lead to the most accurate AI model. Examples of optimizers include Gradient Descent (GD), Adaptive Gradient Algorithm (AdaGrad), Adaptive Moment Estimation (Adam), Root Mean Square Propagation (RMSprop), Radial Base Function (RBF) and Limited-memory BFGS (L-BFGS). The type of optimizer 326 used may be determined based on the type of model structure 320 and the size of data and the computing resources available in the data layer 302.

The regularization engine 328 executes regularization operations. Regularization is a technique that prevents over- and under-fitting of the AI model. Overfitting occurs when the algorithm 316 is overly complex and too adapted to the training data, which can result in poor performance of the AI model. Underfitting occurs when the algorithm 316 is unable to recognize even basic patterns from the training data such that it cannot perform well on training data or on validation data. The optimizer 326 can apply one or more regularization techniques to fit the algorithm 316 to the training data properly, which helps constraint the resulting AI model and improves its ability for generalized application. Examples of regularization techniques include lasso (L1) regularization, ridge (L2) regularization, and elastic (L1 and L2 regularization).

The application layer 308 describes how the AI system 300 is used to solve problem or perform tasks. In an example implementation, the application layer 308 can include application(s) 120 of the computing platform 110 of FIG. 1.

### Example Embodiments of a Component Risk Corrector of the Computing Platform for Cascading Command Set Engineering

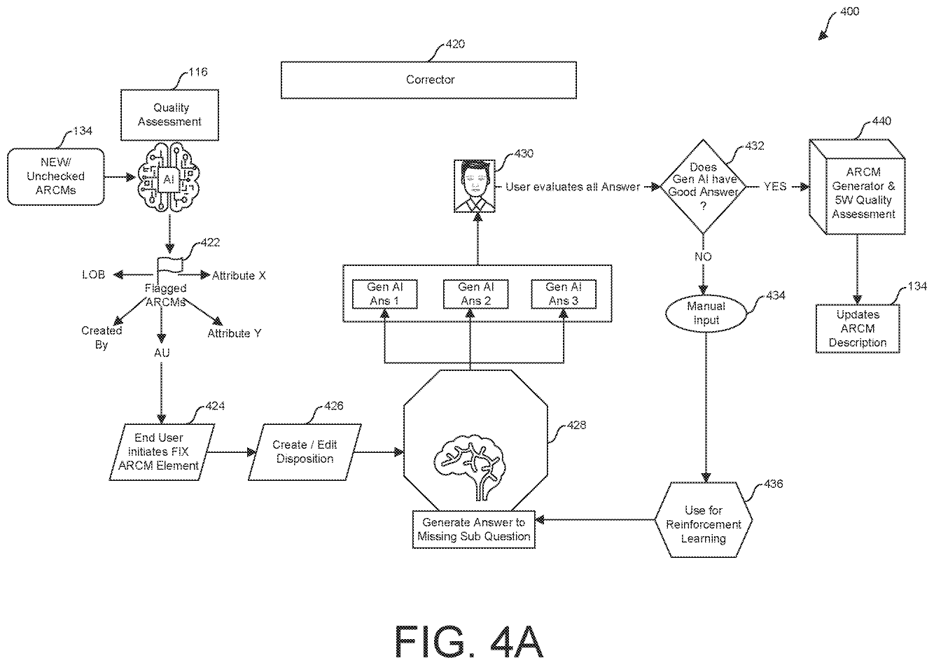

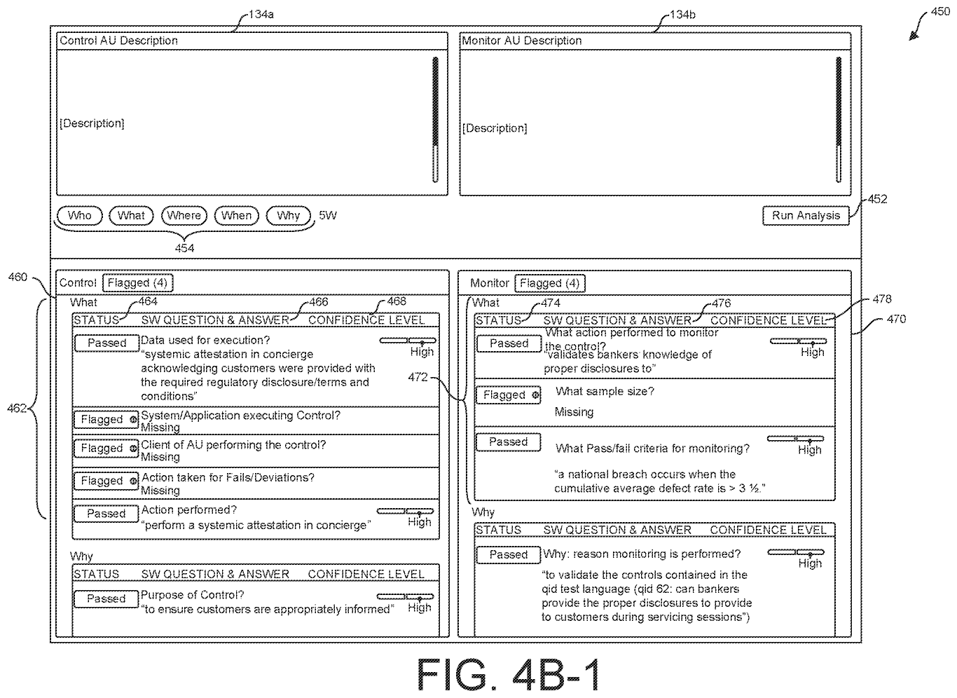

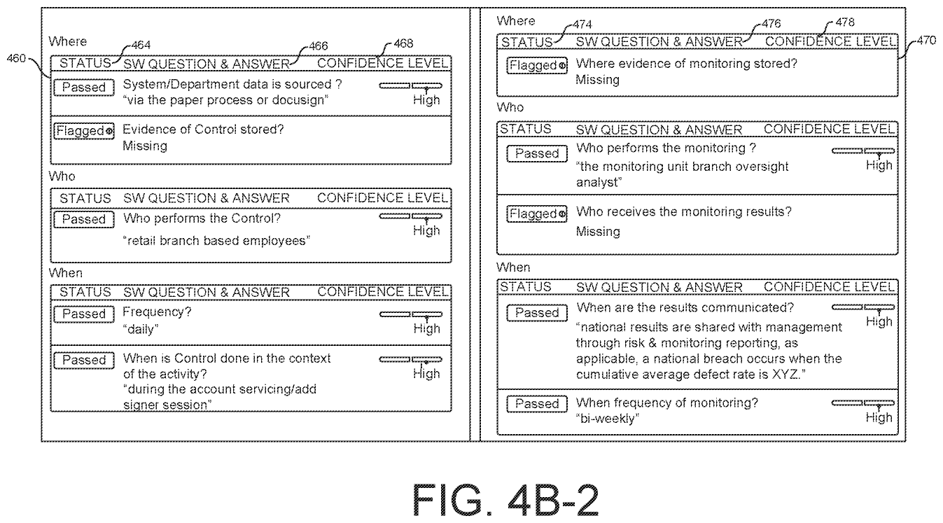

FIGS. 4A, 4B-1 and 4B-2 show an example architecture 400 and GUI 450 of a component risk corrector 420, which can operate as part of the computing platform 110 described in relation to FIG. 1. The component risk corrector 420 can be implemented as an application 120 described in relation to FIG. 1 and can be operable to correct a faulty A-R-C-M chain by generating suggested missing information and facilitating user acceptance. Furthermore, the component risk corrector 420 can check the quality of AI-generated and/or user-entered A-R-C-Ms by executing a trained AI model to perform a 5 W check on the generated activities, risks, controls, and/or monitoring recommendations.

In operation of the component risk corrector 420, system-generated data 134 (for example, activity data, risk data, control data, monitoring data) can be provided to the quality assessment engine 116, which can cause a trained first instance of an AI model 114 to be executed on the system-generated data 134. The output of the AI model 114 can enable the quality assessment engine 116 to flag (at 422) various missing items, such as line of business, author, and so forth. The flagged data can be provided, via a GUI, to the user who can manually correct (at 424) the ARCM element and add (at 426) a disposition annotation. The manually corrected and annotated unit of system-generated data 134 can be provided (at 436) to the command set generator 112, which can generate (at 428) the additional related items in the A-R-C-M chain. The user 430 can evaluate the additional items. If, at decisional 432, the user determines that answers are not correct, the user can manually update (at 434) the corresponding A-R-C-M sets, which can be used (at 436) for reinforcement learning of the AI model 114 that generated (at 428) the additional related items in the A-R-C-M chain. If, at decisional 432, the user determines that answers are correct, the items can be provided (at 440) to a trained AI model 114 to perform a further quality assessment.

A further quality assessment can include a 5 W check, as shown in FIGS. 4B-1 and 4B-2. For instance, the component risk corrector 420 can provide the items (134a, 134b) to a trained transformer model. Upon receiving a user instruction to run analytics (at 452), the model can perform a 5 W assessment (at 454) to evaluate the item (134a, 134b) against a set of 5 W checkpoints. The output of the model can be used by the component risk corrector 420 to generate output panels (460, 470) and populate a test status (464, 474) (e.g., passed, failed, flagged), a description (466, 476) relating to the test status (464, 474), and/or a confidence metric (468, 478) relating to the test status (464, 474). The confidence metric can be a value selected from a range of values (e.g., 1-10, 1-100, 0.0-1.0) and can have a suitable form factor, which can include alphanumeric data (e.g., a numerical score, a letter score) and/or a visual indicator relating to the test status and/or the score (e.g., a slider, a scale).

### Example Methods of Operation

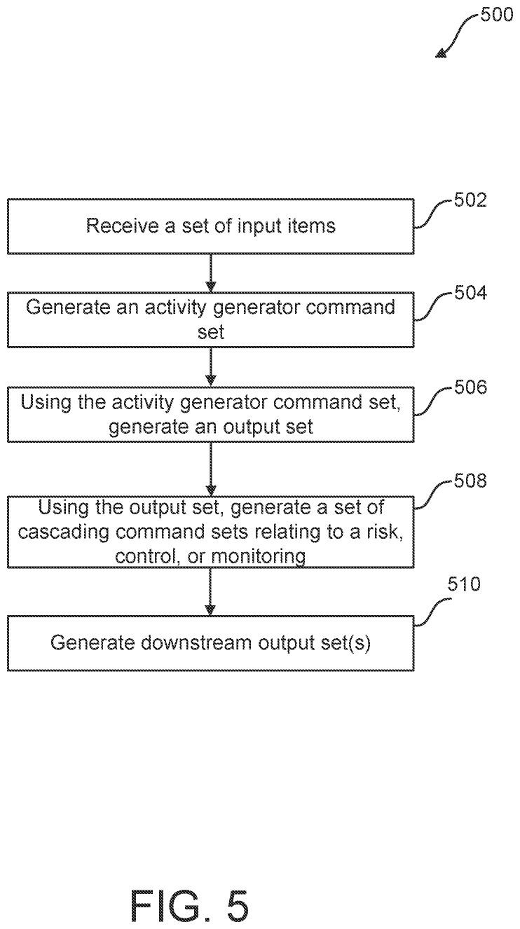

FIG. 5 is a flowchart depicting an example method 500 of operation of the computing platform of FIG. 1, in accordance with some implementations of the present technology. As a general overview, variations of method 500 can include computer-based operations of various components of the computing platform 110, such as application(s) 120. Application(s) 120 can include the component risk generator 220 and the component risk corrector 420. For example, the component risk generator 220 can receive (via a GUI for an executable application, browser-based application, applet, plug-in, chatbot, and so forth) input items. The component risk generator 220 can use information generated based on the input items to automatically generate a prompt (command set) for an AI model.

For example, an automatically generated prompt can be structured to cause the model to generate a list of likely activities associated with a particular system or process component. The prompt can be executed to generate an activity output set that includes a set of activities. The activity output set can be used to generate another prompt, which can be structured to operate on items from the activity output set to return the corresponding risks, controls, and monitoring items for activities in the activity output set. These items can be quality-checked by the component risk corrector 420, which can apply AI model(s) to generate quality metrics, such as test statuses, descriptions, and/or confidence metrics.

Computer-based method 500 enables a host of technical advantages. For example, performing operations to recursively generate sets of activities and their corresponding risks, controls, and monitoring can be error-prone and time-consuming. Automatic, cascading prompt engineering and prompt/model chaining enables prompt and model tuning operations, which can improve the output quality of the AI models that generate the outputs described herein. For example, running AI models becomes more computationally expensive as prompts increase in complexity, particularly when the tasks articulated in a particular prompt necessitate performing recursive operations. Additionally, asking a large model (e.g., a model trained on a comparatively larger corpus of data and having a comparatively higher number of layers and parameters) to return a response to a composite question can result in computationally expensive responses, which can also be unusable due to overfitting to a particular corpus of training data. Breaking large, complex prompts into smaller, comparatively more tailored, prompts that focus on individual segments in the A-R-C-M chain can enable implementation of cascading, smaller AI models. These AI models can be individually trained, which minimizes the possibility of overfitting, optimizes the use of computational resources needed to run the models, and increases transparency when verifying model outputs.

In operation of the computing platform 110, at step 502, the component risk generator 220 can receive a set of input items. The set of input items can include, for example, a user-supplied question, such as “What are the activities, risks, controls, and monitors associated with implementing a vector database?”

Example activities can include, for example, “install a vector database”, “define a data schema”, “import and vectorize the data”, “define database optimizations”, and “maintain the database.” Activities in a set of activities can be associated with a set of risks. For instance, “import and vectorize the data” and “maintain the database” activities can be associated with a risk of “data breach”. Two example controls associated with “data breach” can include, for example, “audit logging” and “data encryption”. An example monitoring operation associated with “audit logging” vector databases can include “CRUD [create, retrieve, update, delete] operation timestamping”. Another example monitoring operation can include, for example, “encryption tool patching”.

The component risk generator 220 can parse the user-supplied question to extract or generate various input items in order to generate (at step 504) a prompt. For example, a prompt can be or include an activity generator command set, such as a use constraint, a role item, an input item, and/or an instruction. For example, tokens in the user-supplied question can map to prompt elements. For example, a use constraint item “vector database” can map to a particular knowledge domain, such as “technology risk” (in a set of domains including “technology risk”, “operational risk”, and “process risk”). As another example, a use constraint token extracted or generated based on the user-supplied question can map to a particular geographical location, region, line of business, layer in a technology stack, and so forth. As another example, a role token can map to a particular entity responsible for a facet of activity or risk (e.g., a department within an organization, such as “Accounting”, “Technology”, “Compliance”). As another example, a model input item can map to another item on which the relevant model was previously trained (e.g., risk data, fraud data, KYC (know your customer) data, system vulnerability data, reported security breach data). For instance, the model input item can be used to increase prompt specificity and thereby improve the quality of model output.

More generally, generating input items for a prompt can include performing pre-processing operations on a portion of the user-supplied question. The pre-processing operations can include cross-referencing a data store (policy store, account store, system configuration information, operational database, administrative database), cross-referencing a user directory, truncating an extracted value, and/or generating a derivative value based on the extracted value. Generating a derivative value can include, for example, cross-referencing an ontology, which can generalize items (e.g., map “New York” to “Northeast”), classify items (e.g., map “vector database” to “storage”), and/or supply synonyms to improve efficiency of the prompt and to more closely match the data on which AI models are trained (e.g., for instruction items, transform “what is” to “define”, “what are” to “generate a list”).

At step 506, the component risk generator 220 can utilize the activity generator prompt to execute an upstream AI model, such as a transformer model or another neural network model. The automatically generated activity generator prompt can be optimized to correspond to features in the corpus of training data on which the upstream AI model was previously trained (e.g., use constraint, role item, model input item, instruction). The AI model can generate an activity output set, such as “install a vector database”, “define a data schema”, “import and vectorize the data”, “define database optimizations”, and “maintain the database.”

At step 508, a series of downstream prompts in the A-R-C-M chain can be constructed and the corresponding downstream AI models can be executed, based on the downstream prompts, in a cascading manner. The downstream AI models generate, at step 510, downstream output items. For example, for a particular activity A₁ in activity set A, the component risk generator 220 can generate a set of risks, R, which can include risk items R₁ through Rₙ. For a particular risk R₁, the component risk generator 220 can generate a set of controls, C, which can include control items C₁ through Cₙ. For a particular control C₁, the component risk generator 220 can generate a set of monitoring operations, M, which can include monitoring items M₁ through Mₙ. In some implementations, a derivative can be generated based on the output item—for example, the output item can be replaced with a synonym or ontology item that matches more closely the training corpus on which a particular downstream model was trained.

These operations can be performed by generating a downstream prompt that includes an appropriate item (e.g., risk item, control item, monitoring item). The item can be generated based on an item included in the output set of the respective upstream AI model in the A-R-C-M chain. In some implementations, the output item is taken as-is. In some implementations, the output item is post-processed—for example, the output item can be automatically validated. As another example, the output can be manually validated (e.g., by being routed to the component risk corrector 420). For example, the computing platform 110 can generate a GUI that enables users to enter additional tokens for any of the items in the A-R-C-M chain. For example, users can manually enter additional activities, risks, controls, and/or monitoring operations, and the computing platform 110 can generate additional downstream elements in the A-R-C-M chain using the manual entries. Generating additional downstream elements can include generating additional (“next”) cascading command sets for the corresponding downstream AI models and additional (“next”, “subsequent”) output items to be included in (e.g., programmatically associated with via a binding) the model-generated output sets. In some implementations, additional data supplied by the users manually via the component risk corrector 420 can be stored as part of training sets for the AI models. Accordingly, the AI models in the A-R-C-M chain can continue to be fine-tuned to ensure that models continue to adapt to changing environments.

For brevity, operations 502-510 of method 500 have been described as a sequence. One of skill will appreciate that these operations can be performed as parallel sequences 506-508-510, 508-510, or the like.

### Example Computing Environment

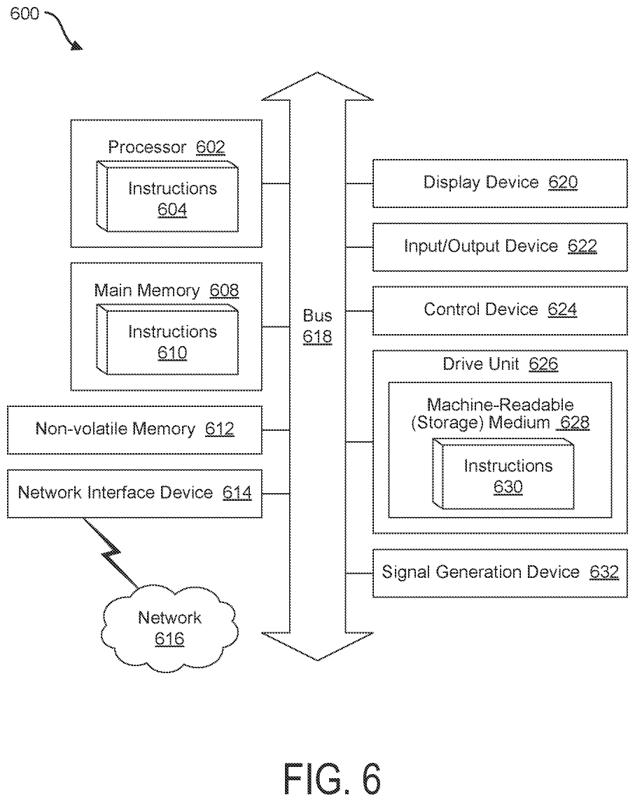

FIG. 6 is a block diagram showing some of the components typically incorporated in at least some of the computer systems and other devices 600 on which the disclosed system operates in accordance with some implementations of the present technology. As shown, an example computer system 600 can include: one or more processors 602, main memory 608, non-volatile memory 610, a network interface device 614, video display device 620, an input/output device 622, a control device 624 (e.g., keyboard and pointing device), a drive unit 626 that includes a machine-readable medium 628, and a signal generation device 632 that are communicatively connected to a bus 618. The bus 618 represents one or more physical buses and/or point-to-point connections that are connected by appropriate bridges, adapters, or controllers. Various common components (e.g., cache memory) are omitted from FIG. 6 for brevity. Instead, the computer system 600 is intended to illustrate a hardware device on which components illustrated or described relative to the examples of the figures and any other components described in this specification can be implemented.

The computer system 600 can take any suitable physical form. For example, the computer system 600 can share a similar architecture to that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computer system 600. In some implementations, the computer system 600 can be an embedded computer system, a system-on-chip (SOC), a single-board computer system (SBC) or a distributed system such as a mesh of computer systems or include one or more cloud components in one or more networks. Where appropriate, one or more computer systems 600 can perform operations in real-time, near real-time, or in batch mode.

The network interface device 614 enables the computer system 600 to exchange data in a network 616 with an entity that is external to the computing system 600 through any communication protocol supported by the computer system 600 and the external entity. Examples of the network interface device 614 include a network adaptor card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 608, non-volatile memory 612, machine-readable medium 628) can be local, remote, or distributed. Although shown as a single medium, the machine-readable medium 628 can include multiple media (e.g., a centralized/distributed database and/or associated caches and servers) that store one or more sets of instructions 630. The machine-readable (storage) medium 628 can include any medium that is capable of storing, encoding, or carrying a set of instructions for execution by the computer system 600. The machine-readable medium 628 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory, removable memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 610, 630) set at various times in various memory and storage devices in computing device(s). When read and executed by the processor 602, the instruction(s) cause the computer system 600 to perform operations to execute elements involving the various aspects of the disclosure.

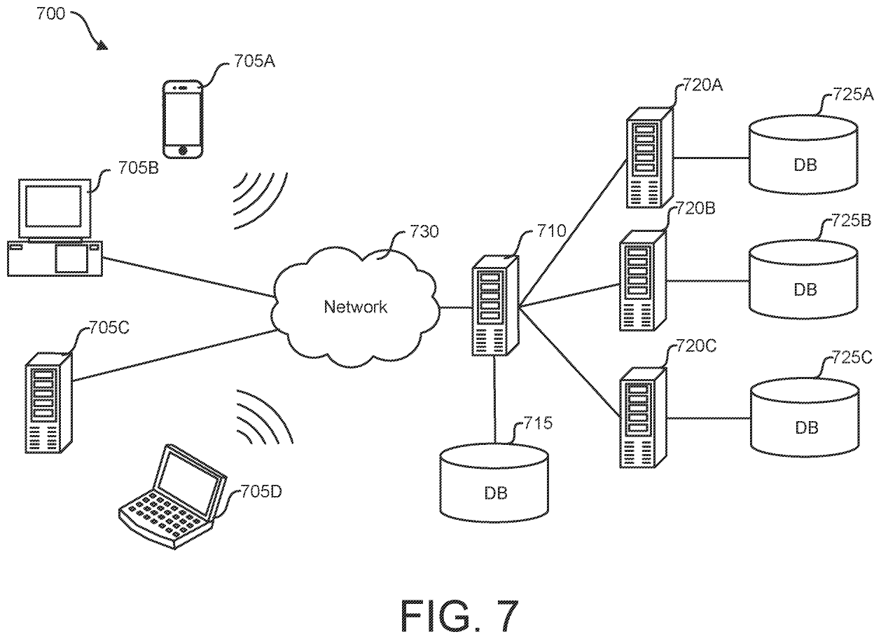

FIG. 7 is a system diagram illustrating an example of a computing environment in which the disclosed system operates in some implementations. In some implementations, environment 700 includes one or more client computing devices 705A-D, examples of which can host the computing platform 110 of FIG. 1. Client computing devices 705 operate in a networked environment using logical connections through network 730 to one or more remote computers, such as a server computing device.

In some implementations, server 710 is an edge server which receives client requests and coordinates fulfillment of those requests through other servers, such as servers 720A-C. In some implementations, server computing devices 710 and 720 comprise computing systems, such as the computing platform 110 of FIG. 1. Though each server computing device 710 and 720 is displayed logically as a single server, server computing devices can each be a distributed computing environment encompassing multiple computing devices located at the same or at geographically disparate physical locations. In some implementations, each server 720 corresponds to a group of servers.

Client computing devices 705 and server computing devices 710 and 720 can each act as a server or client to other server or client devices. In some implementations, servers (710, 720A-C) connect to a corresponding database (715, 725A-C). As discussed above, each server 720 can correspond to a group of servers, and each of these servers can share a database or can have its own database. Databases 715 and 725 warehouse (e.g., store) information. Though databases 715 and 725 are displayed logically as single units, databases 715 and 725 can each be a distributed computing environment encompassing multiple computing devices, can be located within their corresponding server, or can be located at the same or at geographically disparate physical locations.

Network 730 can be a local area network (LAN) or a wide area network (WAN), but can also be other wired or wireless networks. In some implementations, network 730 is the Internet or some other public or private network. Client computing devices 705 are connected to network 730 through a network interface, such as by wired or wireless communication. While the connections between server 710 and servers 720 are shown as separate connections, these connections can be any kind of local, wide area, wired, or wireless network, including network 730 or a separate public or private network.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented in parallel, or may be performed at different times. Further, any specific numbers noted herein are only examples: alternative embodiments may employ differing values or ranges.

The teachings of the technology provided herein can be applied to other systems, not necessarily the system described above. The elements and acts of the various examples described above can be combined to provide further embodiments of the technology. Some alternative embodiments of the technology may include not only additional elements to those embodiments noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, specific terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for,” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

1. One or more non-transitory computer-readable media storing instructions, which when executed by at least one processor of a component risk generator comprising a trained upstream machine learning model, a set of trained downstream machine learning models, an automatic command set generator, and a model quality assessment engine, perform operations for generative model sequencing, the operations comprising:
using a set of input items received via a graphical user interface, generating, by the automatic command set generator, a component activity generator command set comprising a set of component activity generator items,
wherein the set of component activity generator items comprise: (a) a use constraint and (b) two or more of: (i) a role item, (ii) a model input item, or (iii) an instruction;
using a generated component activity generator command set, applying the trained upstream machine learning model configured to generate a component activity output set based on the use constraint and two or more of the role item, the model input item, or the instruction;
using a generated component activity output set, generating, by the automatic command set generator, a set of cascading command sets,
wherein a particular cascading command set in the set of cascading command sets relates to a risk, a control, or a monitoring associated with a particular component activity in the generated component activity output set;
using at least one command set in a generated set of cascading command sets,
applying a set of trained downstream machine learning models to generate a plurality of downstream output sets,
wherein each downstream output set in a generated plurality of downstream output sets comprises a risk item, a control item, or a monitoring item generated for the particular component activity, and
wherein a first one of the risk item, the control item, or the monitoring item is utilized to automatically generate a next cascading command set for a second subsequent one of the risk item, the control item, or the monitoring item; and
causing the graphical user interface to display one or more of the generated plurality of downstream output sets;
generating, and causing the graphical user interface to display, a model quality assessment interface comprising an item from any of the generated plurality of the downstream output sets;
for a particular one or more of a displayed risk item, control item, or monitoring item in a downstream output set of the generated plurality of the downstream output sets, generating a test status and a confidence metric;
based on the test status and the confidence metric, generating, and causing the graphical user interface to display, a visual indicator that relates to the test status and confidence metric; and
in response to at least one of (i) detecting, at the graphical user interface, a first user interaction with the visual indicator or (ii) detecting, by a risk corrector component, an error in the downstream output set, performing operations comprising:
utilizing input provided via a second user interaction, modifying at least a portion of the downstream output set to generate an updated output set; and
using the updated output set, incrementally retraining a particular downstream model that generated the downstream output set to increase accuracy of the particular downstream model,
wherein the particular downstream model is incrementally retrained on additional updated downstream output sets in response to detecting additional errors in additional downstream output sets.

2. The media of claim 1, the operations further comprising, after
causing the graphical user interface to display the plurality of downstream output sets, receiving, via the graphical user interface, an additional input item;
generating, using the additional input item, an additional one of the risk item, the control item, or the monitoring item; and
including the additional one of the risk item, the control item, or the monitoring item in a particular downstream output set.

3. The media of claim 2, the operations further comprising:
generating an additional cascading command set using the particular downstream output set; and
using the additional cascading command set,
applying the set of trained downstream machine learning models to generate a plurality of additional downstream output sets; and
using one of an additional risk item, additional control item, or additional monitoring item in an additional downstream output set, automatically generating a next cascading command set.

4. (canceled)

5. The media of claim 1, wherein generating the test status comprises automatically evaluating one or more the displayed risk item, control item, or monitoring item against a set of checkpoints.

6. The media of claim 5, further comprising:
generating a set of validator input features comprising the one or more of the displayed risk item, control item, or monitoring item and the set of checkpoints;
applying a validator model using the generated set of validator input features; and
based on an output of the validator model, generating the one or more of the test status and the confidence metric.

7. The media of claim 1, wherein generating the component activity generator command set comprises:
parsing the set of input items to generate the set of component activity generator items; and
determining, using the set of component activity generator items, the use constraint.

8. The media of claim 7, wherein the use constraint identifies a domain, the domain relating to technology risk or operational risk.

9. The media of claim 7, wherein the use constraint relates to a region associated with a particular component.

10. The media of claim 7, the operations further comprising generating the set of component activity generator items based on the use constraint from a selected data store.

11. The media of claim 7, wherein parsing the set of input items further comprises pre-processing one or more items in the set of input items via one or more pre-processing operations, the one or more pre-processing operations comprising cross-referencing a data store, cross-referencing a user directory, truncating an extracted value, or generating a derivative value based on the extracted value.

12. The media of claim 1, wherein the graphical user interface comprises chatbot.

13. A computer-implemented method, comprising:
with a component risk control generator comprising a trained upstream machine learning model, a set of trained downstream machine learning models, an automatic command set generator, and a model quality assessment engine,
using a input items received via a graphical user interface, generating, by the automatic command set generator, a component activity generator command set comprising a set of component activity generator items,
wherein the set of component activity generator items comprises: (a) a use constraint and (b) two or more of: (i) a role item, (ii) a model input item, or (iii) an instruction;
using a component activity generator command set, applying the trained upstream machine learning model configured to generate a component activity output set based on the use constraint and two or more of the role item, the model input item, or the instruction;
using a generated component activity output set, generating, by the automatic command set generator, a set of cascading command sets,
wherein a particular cascading command set in the set of cascading command sets relates to a risk, a control, or a monitoring associated with a particular component activity in the generated component activity output set;
using at least one command set in the set of cascading command sets,
applying a set of trained downstream machine learning models to generate a plurality of downstream output sets,
wherein a downstream output set in the plurality of downstream output sets comprises a risk item, a control item, or a monitoring item generated for the particular component activity; and
wherein a first one of the risk item, the control item, or the monitoring item is utilized to automatically generate a next cascading command set for a second one of the risk item, the control item, or the monitoring item; and
causing the graphical user interface to display the plurality of downstream output sets;
generating, and causing the graphical user interface to display, a model quality assessment interface comprising an item from any of the generated plurality of the downstream output sets;
for a particular one or more of a displayed risk item, control item, or monitoring item in a downstream output set of the generated plurality of the downstream output sets, generating a test status and a confidence metric;
based on one or more of the test status and the confidence metric, generating, and causing the graphical user interface to display, a visual indicator that relates to the test status and confidence metric; and
in response to at least one of (i) detecting, at the graphical user interface, a first user interaction with the visual indicator or (ii) detecting, by a risk corrector component, an error in the downstream output set, performing operations comprising:
utilizing input provided via a second user interaction, modifying at least a portion of the downstream output set to generate an updated output set; and
using the updated output set, incrementally retraining a particular downstream model that generated the downstream output set to increase accuracy of the particular downstream model,
wherein the particular downstream model is incrementally retrained on additional updated downstream output sets in response to detecting additional errors in additional downstream output sets.

14. The method of claim 13, further comprising, after causing the graphical user interface to display the plurality of downstream output sets,
receiving, via the graphical user interface, an additional input item;
generating, using the additional input item, an additional one of the risk item, the control item, or the monitoring item; and
including the additional one of the risk item, the control item, or the monitoring item in a particular downstream output set.

15. The method of claim 14, further comprising:
generating an additional cascading command set using the particular downstream output set; and
using the additional cascading command set,
applying the set of trained downstream machine learning models to generate a plurality of additional downstream output sets; and
using one of an additional risk item, additional control item, or additional monitoring item in an additional downstream output set, automatically generating a next cascading command set.

16. (canceled)

17. A computing system comprising:
a component risk control generator comprising a trained upstream machine learning model, a set of trained downstream machine learning models, an automatic command set generator, and a model quality assessment engine;
at least one processor; and
one or more non-transitory computer-readable media storing instructions, which when executed by at least one processor, perform operations comprising:
receiving, via a graphical user interface, a set of input items;
using the set of received input items, generating, by the automatic command set generator, a component activity generator command set comprising a set of component activity generator items,
wherein the set of component activity generator items comprises (a) a use constraint and (b) two or more of: (i) a role item, (ii) a model input item, or (iii) an instruction;
using a component activity generator command set, applying the trained upstream machine learning model configured to generate a component activity output set based on the use constraint and two or more of the role item, the model input item, or the instruction;
using a generated component activity output set, generating, by the automatic command set generator, a set of cascading command sets,
wherein a particular cascading command set in the set of cascading command sets relates to a risk, a control, or a monitoring associated with a particular component activity in the generated component activity output set;
using at least one command set in the set of cascading command sets,
applying a set of trained downstream machine learning models to generate a plurality of downstream output sets,
wherein a downstream output set in the plurality of downstream output sets comprises a risk item, a control item, or a monitoring item generated for the particular component activity; and
wherein a first one of the risk item, the control item, or the monitoring item is utilized to automatically generate a next cascading command set for a second one of the risk item, the control item, or the monitoring item; and
causing the graphical user interface to display the plurality of downstream output sets;
generating, and causing the graphical user interface to display, a model quality assessment interface comprising an item from any of the generated plurality of the downstream output sets;
for a particular one or more of a displayed risk item, control item, or monitoring item in a downstream output set of the generated plurality of the downstream output sets, generating a test status and a confidence metric;
based on the one or more of the test status and the confidence metric, generating, and causing the graphical user interface to display, a visual indicator that relates to the test status and confidence metric; and
in response to at least one of (i) detecting, at the graphical user interface, a first user interaction with the visual indicator or (ii) detecting, by a risk corrector component, an error in the downstream output set, performing operations comprising:
utilizing input provided via a second user interaction, modifying at least a portion of the downstream output set to generate an updated output set; and
using the updated output set, incrementally retraining a particular downstream model that generated the downstream output set to increase accuracy of the particular downstream model,
wherein the particular downstream model is incrementally retrained on additional updated downstream output sets in response to detecting additional errors in additional downstream output sets.

18. The computing system of claim 17, the operations further comprising:
receiving, via the graphical user interface, an additional input item;
generating, using the additional input item, an additional one of the risk item, the control item, or the monitoring item; and
including the additional one of the risk item, the control item, or the monitoring item in a particular downstream output set.

19. The computing system of claim 18, the operations further comprising:
generating an additional cascading command set using the particular downstream output set; and
using the additional cascading command set,
applying the set of trained downstream machine learning models to generate a plurality of additional downstream output sets; and
using one of an additional risk item, additional control item, or additional monitoring item in an additional downstream output set, automatically generating a next cascading command set.

20. (canceled)
